(19) United States
(12) Patent Application Publication
(10) Pub. No.: US 2014/0049465 A1
(43) Pub. Date: Feb. 20, 2014

(54) GESTURE OPERATED CONTROL FOR MEDICAL INFORMATION SYSTEMS

(71) Applicants: Jamie Douglas Tremaine, Parry Sound (CA); Greg Owen Brigley, Indian River (CA); Louis-Matthieu Strickland, Dwight (CA)

(72) Inventors: Jamie Douglas Tremaine, Parry Sound (CA); Greg Owen Brigley, Indian River (CA); Louis-Matthieu Strickland, Dwight (CA)

(21) Appl. No.: 14/008,179

(22) PCT Filed: Mar. 28, 2012
(86) PCT No.: PCT/CA2012/000301

§ 371 Date: Oct. 21, 2013

Related U.S. Application Data
(60) Provisional application No. 61/468,542, filed on Mar. 28, 2011.

(51) Int. Cl. G06F 3/01

(52) U.S. Cl. CPC G06F 3/017
USPC 345/156

(57) ABSTRACT

The embodiments described herein relates to systems, methods and apparatuses for facilitating gesture-based control of an electronic device for displaying medical information. According to some aspects, there is provided a gesture recognition apparatus comprising at least one processor configured receive image data and depth data from at least one camera; extract at least one gesture from the image data and the depth data that is indicative of an activity of an operator within a volume of recognition, the volume of recognition being indicative of a sterile space proximate to the operator; generate at least one command that is compatible with the at least one electronic device based on the extracted at least one gesture; and provide the at least one compatible command to at least one electronic device as an input command.

### TECHNICAL FIELD

The embodiments herein relate to medical information systems, and in particular to methods and apparatus for controlling electronic devices for displaying medical information.

### BACKGROUND

Medical imaging is a technique and process of creating visual representations of a human body, or parts thereof, for use in clinical medicine. Medical imaging includes common modalities such as computed tomography (CT) scanning, magnetic resonance imaging (MRIs), plain film radiography, ultrasonic imaging, and other scans grouped as nuclear medicine.

The images obtained from these processes are often stored and viewed through digital picture archiving and communication systems (PACS). These systems generally provide electronic storage, retrieval, and multi-site, multi-user access to the images. PACS are often used in hospitals and clinics to aid clinicians in diagnosing, tracking, and evaluating the extent of a disease or other medical condition. Furthermore, PACS are often used by proceduralists to help guide them or plan their strategy for a medical procedure such as surgery, insertion of therapeutic lines or drains, or radiation therapy.

The traditional way of viewing and manipulating medical images from the PACS is on a personal computer, using a monitor for output, and with a simple mouse and keyboard for input. The image storage, handling, printing, and transmission standard is the Digital Imaging and Communications in Medicine (DICOM) format and network protocol.

Doctors are placed in a unique quandary when it comes to reviewing the images intended to guide them through an invasive medical procedure. On the one hand, the medical procedure should be conducted under sterile conditions (e.g. to keep rates of infection low). On the other hand, the doctor may want to view or manipulate medical images during the procedure, which could otherwise jeopardize the sterile conditions.

To provide a sterile operating environment, the room where the procedure is being performed is divided into a sterile (“clean”) area and an unsterile (“dirty”) area. Supplies and instrumentation introduced into the sterile area are brought into the room already sterilized. After each use, these supplies are either re-sterilized or disposed of. Surgeons and their assistants can enter the sterile area only after they have properly washed their hands and forearms and donned sterile gloves, a sterile gown, surgical mask, and hair cover. This process is known as “scrubbing”.

Rooms used for invasive procedures often include a PACS viewing station for reviewing medical images before or during a procedure. Since it is not easy or practical to sterilize or dispose computers and their peripherals after each use, these systems are typically set up in the unsterile area. Thus, after the surgical staff has scrubbed and entered the sterile field, they are no longer able to manipulate the computer system in traditional ways while maintaining sterility. For example, the surgical staff cannot use a mouse or keyboard to control the computer system without breaking sterility.

One way for a surgeon to review medical images on the PACS is to ask an assistant to manipulate the images on screen for them. This process is susceptible to miscommunication and can be a frustrating and slow process, especially for a surgeon who is accustomed to reviewing imaging in their own way and at their own pace.

A second approach is for the surgeon to use the computer in the traditional, hands-on way. However, this contaminates the surgeon and therefore requires that the surgeon rescrub and change their gloves and gown to re-establish sterility.

A third approach is to utilize a system that accesses the PACS system using voice activation or pedals without breaking sterility. However, these systems can be difficult to use, require the surgeon to have the foresight to prepare them appropriately, tend to be low fidelity, and can clutter the sterile field.

Accordingly, there is a need for an improved apparatus and method for controlling electronic devices for displaying medical information.

### SUMMARY

According to some aspects, there is provided a gesture recognition apparatus including at least one processor configured to couple to at least one camera and at least one electronic device for displaying medical information. The at least one processor is configured to receive image data and depth data from the at least one camera; extract at least one gesture from the image data and the depth data that is indicative of an activity of an operator within a volume of recognition, the volume of recognition being indicative of a sterile space proximate to the operator; generate at least one command that is compatible with the at least one electronic device based on the extracted at least one gesture; and provide the at least one compatible command to the at least one electronic device as an input command.

According to some aspects, there is provided a gesture-based control method that includes receiving image data and depth data from at least one camera; extracting at least one gesture from the image data and the depth data that is indicative of an activity of an operator within a volume of recognition, the volume of recognition being indicative of a sterile space proximate to the operator; generating at least one command that is compatible with at least one electronic device for displaying medical information based upon the extracted at least one gesture; and providing the at least one compatible command to the at least one electronic device as an input command.

According to some aspects, there is provided a medical information system including at least one camera configured to generate image data and depth data, at least one electronic device configured to receive at least one input command and display medical information based upon the received at least one input command, and at least one processor operatively coupled to the at least one camera and the at least one electronic device. The processor is configured to receive the image data and the depth data from the at least one camera; extract at least one gesture from the image data and the depth data that is indicative of an activity of an operator within a volume of recognition, the volume of recognition being indicative of a sterile space proximate to the operator; generate at least one command that is compatible with the at least one electronic device based on the extracted at least one gesture; and provide the at least one compatible command to the at least one electronic device as the at least one input command.

### BRIEF DESCRIPTION OF THE DRAWINGS

Some embodiments will now be described, by way of example only, with reference to the following drawings, in which:

FIG. 1 is a schematic diagram illustrating a gesture-based control system according to some embodiments;

FIG. 2A is a schematic diagram illustrating a volume of recognition that the processor shown in FIG. 1 is configured to monitor;

FIG. 2B is a schematic side view of an operator shown in relation to the height and length of the volume of recognition shown in FIG. 2A;

FIG. 2C is a schematic front view of an operator shown in relation to the width of the volume of recognition shown in FIG. 2A;

FIG. 3 is a gesture that may be extracted by the processor shown in FIG. 1;

FIG. 4 is a gesture that may be extracted by the processor shown in FIG. 1;

FIG. 5 is a gesture that may be extracted by the processor shown in FIG. 1;

FIG. 6A is a gesture that may be extracted by the processor shown in FIG. 1;

FIG. 6B is a schematic diagram illustrating virtual grid for mapping the gesture shown in FIG. 6A;

FIG. 6C is a schematic diagram illustrating a gesture that may be extracted by the processor shown in FIG. 1;

FIG. 6D is a schematic diagram illustrating a gesture that may be extracted by the processor shown in FIG. 1;

FIG. 7A is a gesture that may be extracted by the processor shown in FIG. 1;

FIG. 7B is a schematic diagram illustrating a gesture that may be extracted by the processor shown in FIG. 1;

FIG. 8 is a gesture that may be extracted by the processor shown in FIG. 1;

FIG. 9 is a gesture that may be extracted by the processor shown in FIG. 1;

FIG. 10 is a gesture that may be extracted by the processor shown in FIG. 1;

FIG. 11 is a gesture that may be extracted by the processor shown in FIG. 1;

FIG. 12 is a schematic diagram illustrating an exemplary configuration of the communication module shown in FIG. 1; and

FIG. 13 is a flowchart illustrating steps of a gesture-based method for controlling a medical information system according to some embodiments.

### DETAILED DESCRIPTION OF THE INVENTION

For simplicity and clarity of illustration, where considered appropriate, reference numerals may be repeated among the figures to indicate corresponding or analogous elements or steps. In addition, numerous specific details are set forth in order to provide a thorough understanding of the exemplary embodiments described herein. However, it will be understood by those of ordinary skill in the art that the embodiments described herein may be practiced without these specific details. In other instances, well-known methods, procedures and components have not been described in detail so as not to obscure the embodiments generally described herein.

Furthermore, this description is not to be considered as limiting the scope of the embodiments described herein in any way, but rather as merely describing the implementation of various embodiments as described.

In some cases, the embodiments of the systems and methods described herein may be implemented in hardware or software, or a combination of both. In some cases, embodiments may be implemented in one or more computer programs executing on one or more programmable computing devices comprising at least one processor, a data storage device (including in some cases volatile and non-volatile memory and/or data storage elements), at least one input device, and at least one output device.

In some embodiments, each program may be implemented in a high level procedural or object oriented programming and/or scripting language to communicate with a computer system. However, the programs can be implemented in assembly or machine language, if desired. In any case, the language may be a compiled or interpreted language.

In some embodiments, the systems and methods as described herein may also be implemented as a non-transitory computer-readable storage medium configured with a computer program, wherein the storage medium so configured causes a computer to operate in a specific and predefined manner to perform at least some of the functions as described herein.

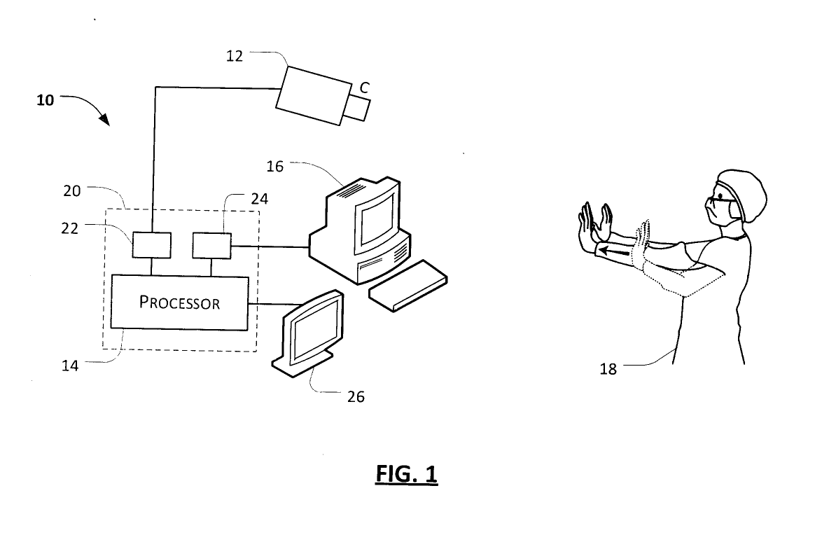

Referring now to FIG. 1, illustrated therein is a medical information system 10 featuring gesture based control according to some embodiments. The system 10 includes a camera 12 operatively coupled to a processor 14, which in turn is operatively coupled to an electronic device 16 for displaying medical information. The system 10 facilitates control of the electronic device 16 based upon gestures performed by an operator, for example an operator 18 shown in FIG. 1.

The camera 12 is configured to generate depth data and image data that are indicative of features within its operational field-of-view. If the operator 18 is within the field-of-view of the camera 12, the depth data and the image data generated by the camera 12 may include data indicative of activities of the operator 18. The depth data, for example, may include information indicative of the activities of the operator 18 relative to the camera and the background features. For example, the depth data may include information about whether the operator 18 and/or a portion of the operator 18 (e.g. the operator's hands) has moved away from the operator's body or towards the operator's body. The image data, generally, is indicative of the RGB data that is captured within the field-of-view of the camera 12. For example, the image data may be RGB data indicative of an amount of light captured at each pixel of the image sensor.

In some embodiments, the camera 12 may include one or more optical sensors. For example, the camera 12 may include one or more depth sensors for generating depth data and a RGB sensor for generating image data (e.g. using a Bayer filter array). The depth sensor may include an infrared laser projector and a monochrome CMOS sensor, which may capture video data in three-dimensions under ambient light conditions.

The camera 12 may include hardware components (e.g. processor and/or circuit logic) that correlate the depth data and the image data. For example, the hardware components may perform depth data and image data registration, such that the depth data for a specific pixel corresponds to image data for that pixel. In some embodiments, the camera 12 may be commercially available camera/sensor hardware such as the Kinect™ camera/sensor marketed by Microsoft Inc or the Wavi™ Xtion™ marketed by ASUSTek Computer Inc.

In some embodiments, the camera 12 may include a LIDAR, time of flight, binocular vision or stereo vision system. In stereo or binocular vision, the depth data may be calculated from the captured data.

The processor 14 is configured to receive the image data and depth data from the camera 12. As shown in FIG. 1, the processor 14 may be part of a discrete gesture-based control device 20 that is configured to couple the camera 12 to the electronic device 16.

The gesture-based control device 20 may have a first communication module 22 for receiving image data and depth data from the camera 12. The gesture-based control device 20 may also have a second communication module 24 for connecting to the electronic device 16.

The first input communication module 22 may or may not be the same as the second communication module 24. For example, the first communication module 22 may include a port for connection to the camera 12 such as a port for connection to a commercially available camera (e.g. a USB port or a FireWire port). In contrast, the second communication module 24 may include a port that is operable to output to ports used by the electronic device 16. For example, the electronic device 16 may have ports for receiving standard input devices such as keyboards and mice (e.g. a USB port or a PS/2 port). In such cases, the second communication module 24 may include ports that allow the gesture-based control device 20 to connect to the ports found on the electronic devices 16. In some embodiments, the connection between the second communication module 24 and the electronic device 16 could be wireless.

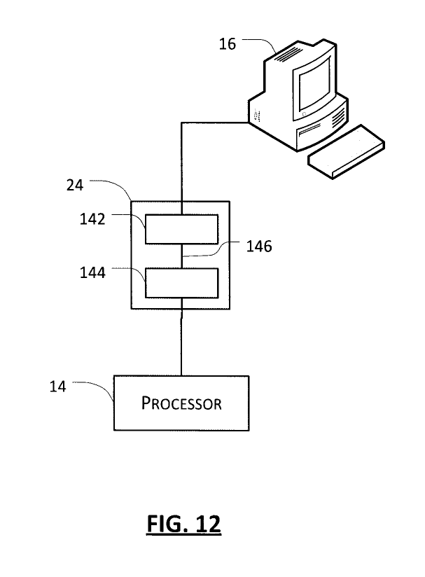

In some embodiments, one or more of the communication modules 22 and 24 may include microcontroller logic to convert one type of input to another type of input. An exemplary configuration for the microcontroller is described with reference to FIG. 12 herein below.

The processor 14 is configured to process the received image data and depth data from the camera 12 to extract selected gestures that the operator 18 might be performing within the field-of-view. The processor 14 processes at least the depth data to view the depth field over time, and determines whether there are one or more operators 18 in the field-of-view, and then extracts at least one of the operator's gestures, which may also be referred to as “poses”. Generally, the image and depth data is refreshed periodically (e.g. every 3-5 milliseconds) so the processor 14 processes the image data and the depth data at a very short time after the occurrence of the activity. (i.e. almost real-time)

In some embodiments, the processor 14 may be configured to perform a calibration process prior to use. The calibration process, for example, may include capturing the features where there are no operators 18 present within the field-of view. For example, the processor 14 may process image data and depth data that are captured by the camera when there are no operators within the field-of-view of the camera 12 to generate calibration data that may be used subsequently to determine activities of the operator 18. The calibration data, for example, may include depth manifold data, which is indicative of the depth values corresponding to the features within the field-of-view. The depth manifold, for example, could have a 640×480 or a 600×800 pixel resolution grid representing the scene without any operators 18 that is captured by the camera 12. For each pixel within the grid, a RGB (red, green, blue) value and a depth value “Z” could be stored. The depth manifold data could be used by the processor subsequently to determine actions performed by the operator 18. In some embodiments, the depth manifold data may have other sizes and may store other values.

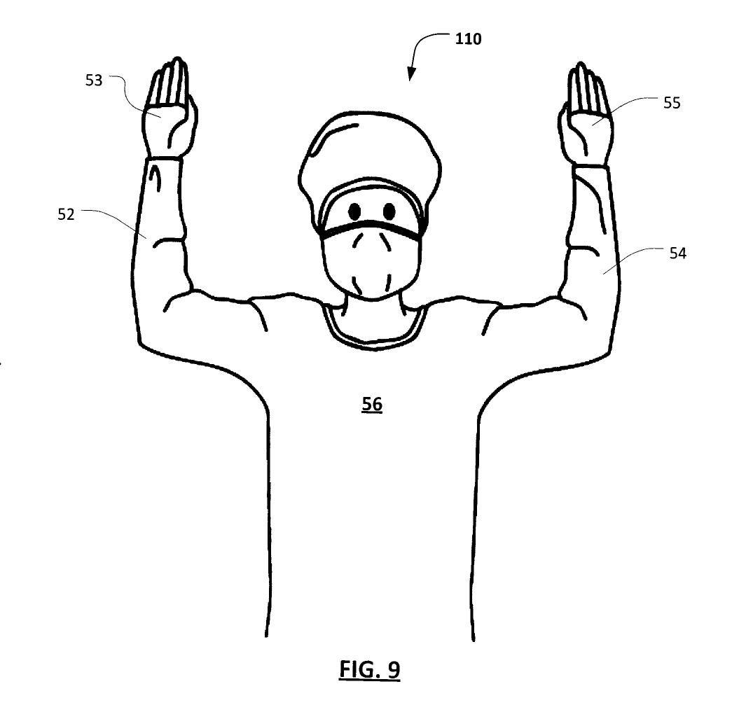

In some embodiments, the processor 14 may be configured to perform a calibration process that includes the operator 18 executing a specified calibration gesture. The calibration process that includes the operator 18 may be performed in addition to or instead of the calibration process without the operator described above. The calibration gesture, for example, may be the gesture 110 described herein below with reference to FIG. 9.

The processor 14 is configured to extract one or more gestures being performed by the operator 18 from the received image data and/or depth data. The processor 14, in some embodiments, may be configured to perform various combinations of gesture extraction process to extract the gestures from the received image data and depth data. The gesture extraction processes, for example, may include segmenting the foreground objects from the background (Foreground Segmentation), differentiating the foreground objects (Foreground Object Differentiation), extracting a skeleton from the object (Skeleton Extraction), and recognizing the gesture from the skeleton (Gesture Recognition). Exemplary implementation of these extraction processes are provided herein below.

The processor 14 may be configured to perform Foreground Segmentation based upon the depth data from the camera 12. Foreground objects can be segmented from the background by recording the furthest non-transient distance for each point of the image for all frames. It should be understood that the “objects” above could include any features in the field-of-view of the camera that are not in the background, including, the operator 18. In order to allow for camera movement, the furthest non-transient distance for each point of the image can be evaluated over a subset of the most recent frames. In this context, a moving object will appear as a foreground object that is separate from the background.

There may be various challenges that may inhibit the ability to extract the foreground object from the background features. For example, the depth camera 12 may experience blind spots, shadows, and/or an infinite depth of field (e.g. glass or outside range of infrared sensor). Furthermore, there could be reflective surfaces (e.g. mirrors) that could cause reflections, and in some cases the camera 12 could be moving. These challenges may be solved by using a variety of techniques. For example, an algorithm may be used to track the furthest depth “Z” value at each point. This may enhance robustness of the Foreground Segmentation. In some embodiments, the algorithm may utilize histograms or other various average last distance measurements including mode and averaging over a window, and using buckets to measure statistical distribution. In some cases optical flow and SIFT and/or SURF algorithms may be used. However, these algorithms may be computationally intensive.

In some embodiments, the processor 14 may also be configured to perform a Foreground Object Differentiation process to differentiate an object from the foreground. This may assist in extracting gestures from the image and depth data. In some cases, the foreground objects may be segmented (e.g. differentiated) from one another through depth segmentation and/or optical flow segmentation.

Generally, the depth segmentation process may be used in a situation where foreground objects that have borders that are depth-discontinuous and are segmented from one another. Optical flow segmentation and optical flow techniques may then be applied to segment the foreground objects from each other.

The optical flow segmentation process may utilize a machine vision technique wherein one or more scale and rotation invariant points of interest detector/labeller are tracked over a sequence of frames to determine the motion or the “flow” of the points of interest. The points of interest, for example may correspond to one or more joints between limbs of an operator's body. The points of interest and their motions can then be clustered using a clustering algorithm (e.g. to define one or more objects such as an operator's limbs). A nonlinear discriminator may be applied to differentiate the clusters from each other. Afterwards, each cluster can be considered as a single object. Furthermore, limbs of the operator can be seen as sub-clusters in a secondary discrimination process.

In some embodiments, the processor 14 may be configured to execute the optical flow segmentation on the image data stream, and combine the results thereof with the depth camera segmentation results, for example, using sensor fusion techniques.

In some embodiments, the processor 14 may also be configured to extract a skeleton of the operator from the image data and the depth data. This Skeleton Extraction process may assist in recognizing the gestures performed by the operator. In some embodiments, the process to extract the skeleton may be performed after one or more of the above-noted processes (e.g. Foreground Segmentation and Foreground Object Differentiation).

To extract the skeleton from a foreground object (e.g. one of the foreground objects (which may include the operator) generated by the processes described above), the processor 14 may be configured to process the depth data of that object to search for a calibration pose. The calibration pose, for example, could be the calibration gesture 110 described herein below with reference to FIG. 9. Once the calibration pose is detected, a heuristic skeletal model may be applied to the depth camera image, and a recursive estimation of limb positions may occur. This recursive method may include one or more of the following steps:
1. An initial estimate of each joint position within the skeletal model may be generated (e.g. a heuristic estimate based on the calibration pose); and
2. The calibration pose may be fitted to the skeletal model. Furthermore, the position of each joint within the skeletal model may be corrected based on a static analysis of the depth data corresponding to the calibration pose. This correction may be performed using appearance-based methods such as: thinning algorithms and/or optical flow sub-clustering processes, or using model-based methods.

The steps may be repeated to generate confidence values for joint positions of the skeletal model. The confidence values may be used to extract the skeleton from the foreground object. This process may iterate continuously, and confidence values may be updated for each joint position.

The processor 14 may be configured to recognize the gestures based on the extracted skeleton data. In some embodiments, the extracted skeleton data may be transformed so that the skeleton data is referenced to the operator's body (i.e. body-relative data). This allows the processor 14 to detect poses and gestures relative to the users' body, as opposed to their orientation relative to the camera 12.

The desire for medical personal to maintain sterility in a medical environment tends to limit the types of gestures that can be used to control the electronic device 16. In an operating room environment, there are a number of general rules that are followed by surgical personnel to reduce the risk of contaminating their patient. For example, the back of each member of the scrubbed surgical team is considered to be contaminated since their sterile gown was tied from behind by a non-sterile assistant at the beginning of the medical procedure. Anything below the waist is also considered to be contaminated. Furthermore, the surgical mask, hat, and anything else on the head are considered contaminated. The operating room lights are contaminated except for a sterile handle clicked into position, usually in the centre of the light. It is considered a dangerous practice for the surgical personnel to reach laterally or above their head since there is a chance of accidentally touching a light, boom, or other contaminated objects.

These considerations tend to limit the net volume of space available for gestures and poses. A limited volume of space proximate to the operator that is available for the operator to execute activities without unduly risking contamination may be referred to as a volume of recognition. That is, the processor 14 may be configured to recognize one or more gestures that are indicative of activities of the operator within the volume of recognition. It should be understood that the space defined by the volume of recognition is not necessarily completely sterile. However, the space is generally recognized to be a safe space where the operator may perform the gestures without undue risk of contamination.

In some cases, the processor 14 may be configured to disregard any activity that is performed outside of the volume of recognition. For example, the processor 14 may be configured to perform gesture recognition processes based upon activities performed within the volume of recognition. In some embodiments, the image data and depth data may be pruned such that only the portion of the image data and the depth data that are indicative of the activity of the operator within the volume of recognition is processed by the processor 14 to extract one or more gestures performed by the operator.

In some embodiments, the entire image data may be processed to extract gestures performed by the operator. However, the processor 14 may be configured to recognize the gestures that are indicative of an activity of the operator within the volume of recognition.

In some cases, the gestures that are being performed outside of the volume of recognition may be disregarded for the purpose of generating commands for the electronic device. In some cases, the gestures performed outside the volume of recognition may be limited to generate commands that are not normally used when maintaining a sterile environment (e.g. to calibrate the system prior to use by medical personnel or to shut the system down after use).

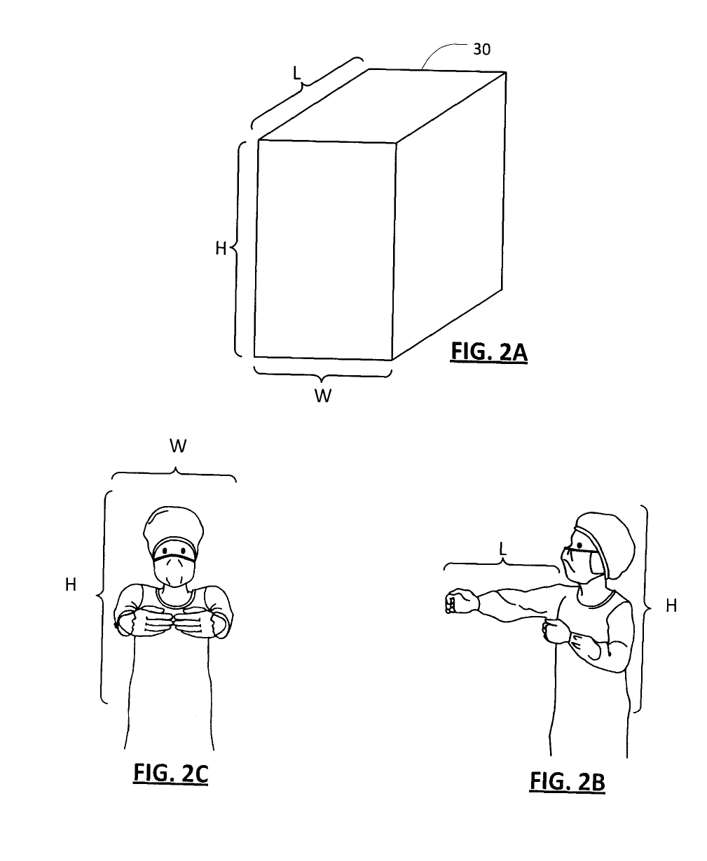

Referring now to FIGS. 2A-2C, illustrated therein is an exemplary volume of recognition indicated by reference numeral 30 according to some embodiments. The volume of recognition 30 may be represented by a rectangular box having a length “L”, a height “H” and a width “W”. In other examples, the volume of recognition could have other shapes such as spherical, ellipsoidal, and the like.

In some embodiments, the volume of recognition may extend anteriorly from the operator. That is, the volume of recognition can be defined relative to the operator regardless of the relative position of the camera to the operator. For example, the camera 12 could be positioned in front of the operator or at a side of the operator.

As shown in FIG. 2B, the volume of recognition may have a height “H” that extends between a waist region of the operator to a head region of the operator 18. For example, the height “H” may be the distance between an inferior limit (e.g. near the waist level), and a superior limit (e.g. near the head level). In some embodiments, the superior limit may be defined by the shoulder or neck level.

Also shown in FIG. 2B, the volume of recognition may have a length “L” that extends arms-length from a chest region of the operator 18. For example, the length “L” may be the distance extending anteriorly from the operator's chest region to the tips of their fingers.

As shown in FIG. 2C, the volume of recognition may have a width “W” that extends between opposed shoulder regions of the operator 18 (e.g. between a first shoulder region and a second shoulder region). For example, the width “W” may be the distance between a left shoulder and a right shoulder (or within a few centimetres of the shoulders).

The processor 14 may be configured to recognize a number of useful positional landmarks to assist with identifying various gestures from the image data and depth data. For example, the processor 14 may be configured to recognize the plane of the chest and its boundaries (e.g. L×H), the elbow joint, the shoulder joints, and the hands. These features may be recognized using the skeletal data. The gestures and poses of the operator described herein below could be extracted based upon these positional landmarks. Having the positional landmarks relative to operator may be advantageous in comparison to recognizing gestures based upon absolute positions (e.g. immobile features of the operating room) as absolute positions may be difficult to establish and complicated to organize.

In some embodiments, the processor 14 may be configured to extract one or more of the following gestures from the image data and depth data. Based on the gesture that is extracted, the processor 14 may generate one or more compatible commands to control the electronic device 16. Exemplary commands that are generated based on the gestures are also described herein. However, it should be understood that in other examples, one or more other control commands may be generated based on the gestures extracted.

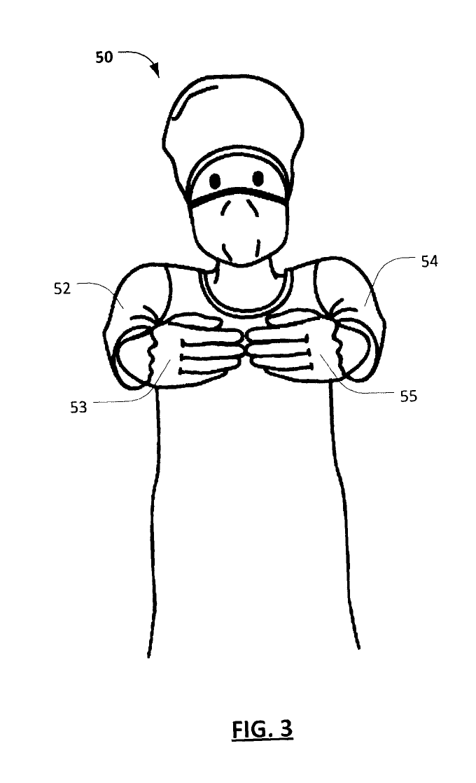

Referring now to FIGS. 3, 4 and 5, the processor 14 may be configured to extract gestures 50, 60, and 70 illustrated therein.

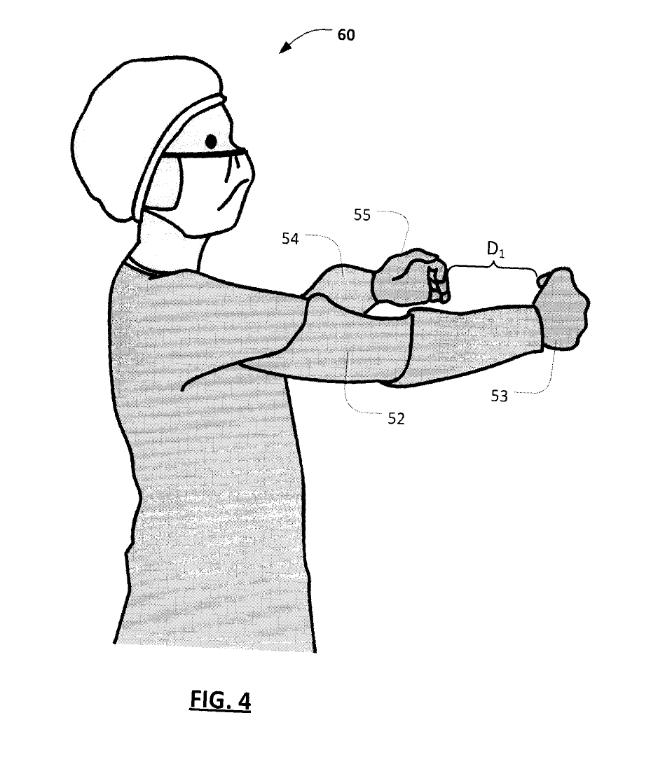

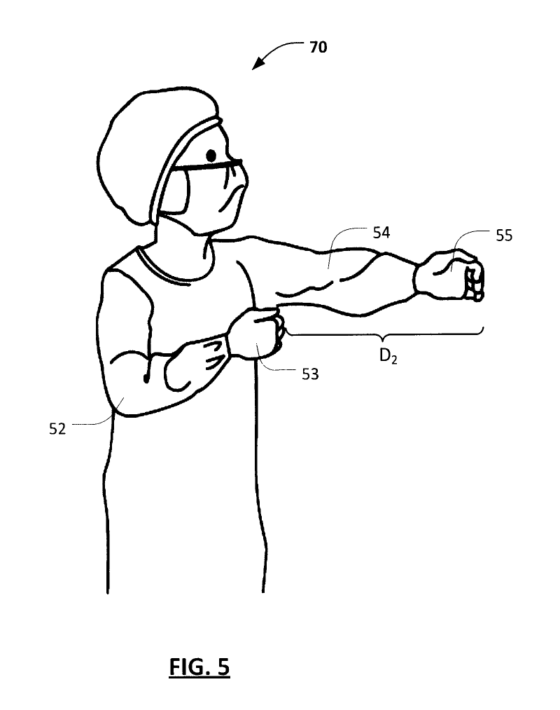

As shown, gesture 50 comprises the operator extending both arms 52, 54 anteriorly from the chest 56 (e.g. at about nipple height). From here, the relatively anteroposterior position of one hand 53 in relation to the other hand 55 could be recognized. These gestures could dictate a simple plus-minus scheme, which may be useful for fine control. For example the gesture 60 could include the right arm 52 being extended anteriorly (and/or the left arm 54 being retracted) such that the right hand 53 is beyond the left hand 55 as shown in FIG. 4. The gesture 70 could be the left arm 54 being extended anteriorly beyond the right arm (and/or the right arm 52 being retracted) such that the left hand 55 is beyond the right hand 53 as shown in FIG. 5.

Based on these gestures 50, 60, 70 compatible commands could be generated. For example, these gestures could be used to generate commands associated with continuous one-variable manipulation such as in a plus-minus scheme. For example, the gesture 60 could indicate a positive increment of one variable while the gesture 70 could indicate a negative increment. For example, the gesture 60 shown in FIG. 4 could be used to indicate scroll-up command in a mouse, and the gesture 70 could be used to indicate scroll-down command in a mouse. The gestures 60, 70 may be used for other commands such as zooming in and zooming out of a medical image. The gestures 60,70 may be used to scroll within a medical document/image or scroll between medical documents/images.

In some embodiments, the distance between the hands could be monitored and this information could be used to determine the size of the increment. In some embodiments, the palms of the hands 53, 55 could face each other and the metacarpophalangeal joints flexed at 90 degrees so that the fingers of each hand 53, 55 are within a few centimetres of each other as shown in FIGS. 4 and 5. This may improve accuracy in measuring the relative distance of the hands 53, 55.

Referring to FIG. 4, the distance D1 between the hands 53 and 55 could be indicative of a first amount of increment. Similarly, the distance D2 in FIG. 5 between the hands 53 and 55 could be indicative of a second amount of increment. When the hands 53 and 55 are within a certain distance of each other, no increment may take place.

If the command generated based upon the gesture 60 in FIG. 4 is a scroll-up command, the distance D1 could be indicative of a number of lines to scroll up. Similarly, the distance D2 could be indicative of number lines to scroll down. As D2 is larger than D1, the compatible command generated based on gesture 70 may cause the electronic device 16 to scroll more lines in comparison to the number of lines that were scrolled up based on the command generated based upon gesture 60. In some embodiments, the gestures may be used to generate commands that are indicative of the direction and speed of scrolling (rather than the exact number of lines to scroll).

In some embodiments, the relative motion of the hands 53, 55 could be measured relative to the superior-inferior plane, parallel to the longer axis of the body's plane to determine increment size. That is, the relative motion of the hands may be “up and down” along the same axis as the height of the operator.

In some embodiments, the relative motion of the hands 53, 55 could be measured relative to the lateral-medial, parallel to the shorter axis of the body's plane. That is, the relative motion of the hands may be “side-to-side” along the horizontal axis.

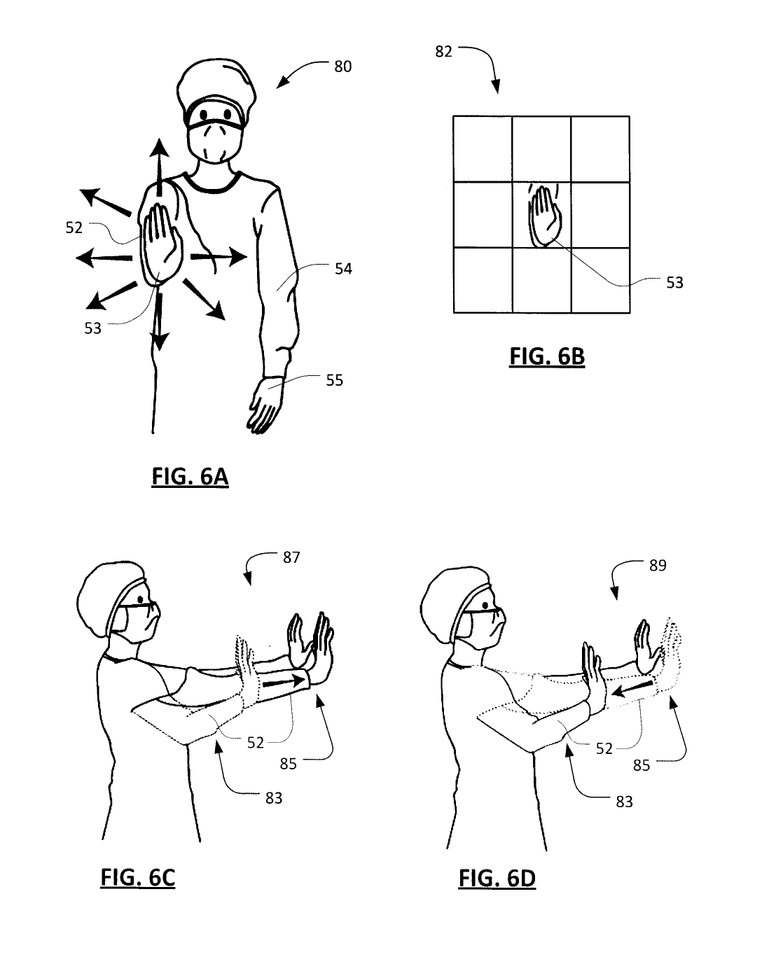

Referring now to FIGS. 6A, 6B, 7 and 8, the processor 14 may be configured to extract gestures 80, 90 and 100 illustrated therein. These gestures 80, 90 and 100 may be completed with the palm of the operator's hands facing away from the chest 56 in some embodiments.

Gesture 80 illustrates how the right arm 52 could be used as a type of joystick control with the multidimensional hinge located at the shoulder. In other embodiments, the left arm 54 may be used. Generally, the arm that is not used (e.g. the arm 54) may be in a rest position (e.g. at the operator's side as shown). This may reduce interference with the gesture recognition of the other arm.

A virtual grid 82 as shown in FIG. 6B comprising nine distinct (i.e. non-overlapping) areas could be established in the plane of the chest of the operator. The nine areas could include a top-left, top-middle, top-right, centre-left, centre-middle, centre-right, bottom-left, bottom-middle, and bottom-left area. The location of the centre of the grid 82 could be established relative to the right shoulder or the left shoulder depending on whether the arm 52 or 54 is being used. The grid 82 could be used to virtually map one or more gestures. For example, the processor 14 could be configured to recognize a gesture when the most anterior part of the outstretched arm 52 (e.g. the hand 53), is extended into one of the areas of the grid 82. For example, the position of the hand 53 in FIG. 6A may correspond to the centre-middle area as shown in FIG. 6B.

In some embodiments, a virtual grid and a centre of the grid may be established based on a dwell area. The dwell area is set by moving the left arm 54 to the extended position. The extension of the arm 54 sets the dwell area. For example, referring to FIG. 6C, the gesture 87 as shown comprises extension of the arm from a first position 83 to a second position 85 may set the dwell area at the location of the hand 53. In other words, the dwell area may be set when the operator holds his right hand up anteriorly and taps forward (e.g. moves forward in the z-plane past 80% arm extension).

When the dwell area is set, a virtual grid may be established in a plane that is transverse (e.g. perpendicular) to the length the arm. The grid 82 described above is formed when the operator extends his arm “straight out” (i.e. perpendicular to the chest plane). The location of the hand area when the arm is fully extended forms the dwell area. Any motion relative to the dwell area may be captured to generate commands (e.g. to move the mouse pointer).

After the dwell area is set, it may be removed when the extended hand is withdrawn. For example as shown in FIG. 6D, when the gesture 89 that comprises retraction of the arm 52 from the second position 85 to the first position 83 is executed, the dwell area may be withdrawn. In some cases, when the arm 52 is below a certain value in the z-plane (e.g. 30%), the dwell area may be removed.

A new dwell area may be set when the hand is re-extended. It should be noted that it is not necessary for the arm to extend directly in front of the operator to set the dwell area. For example, the arm may be extended at an axis that is not normal to the chest plane of the operator. Setting the dwell area and the virtual grid relative to the extension motion of operator's arm may be more intuitive for the operator to generate commands using the extended arm.

In some cases, the distance between the dwell area and the current position of the hand may be indicative of the speed of movement of the mouse pointer. The grid may be a continuous grid comprising a plurality of areas in each direction. In some cases, a transformation (e.g. cubic) may be applied to the distance between the position of the hand and the dwell area to determine the rate of movement.

In some embodiments, the processor 14 may be configured to generate commands that provide continuous or simultaneous control of two-variables based upon various positions of the gestures 80. Increment values could be assigned to each area of the grid 82. For instance top-right could be considered (+,+) while bottom-left would be (−,−). That is, the values could represent direction of increment. For example, the top right would represent an increment in both the x-value and the y-value while the bottom left would represent a decrease in both values. These values could be translated into mouse movements. For example, the value (3,−2) may represent 3 units to the right and 2 units down.

In some embodiments, a virtual grid could be established perpendicular to the plane of the chest and lying flat in front of the operator. The centre point could be defined by outstretching a single arm anteriorly, at bellybutton height, and with elbow bent to 90 degrees. The other hand and arm could then be used to hover over that outstretched hand into one of the nine quadrants.

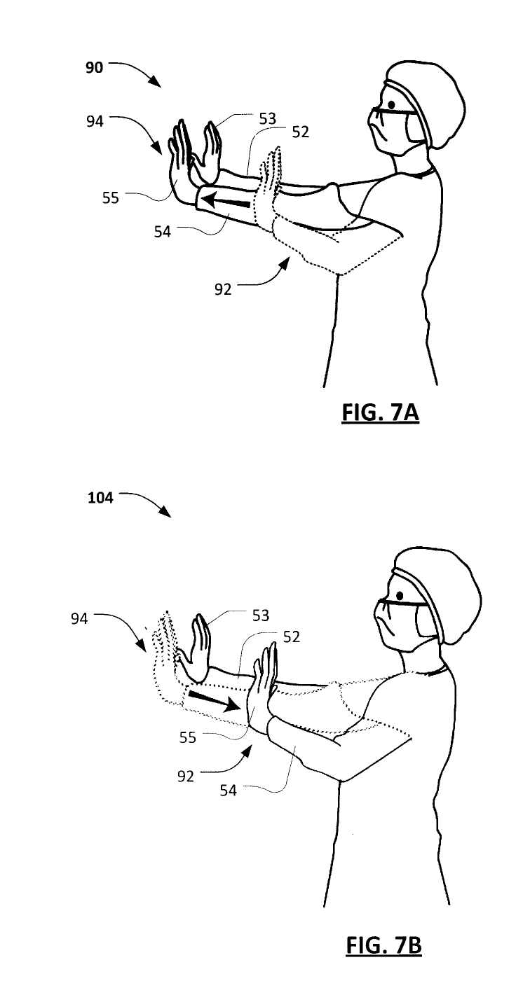

Referring now to FIG. 7A, illustrated therein is the gesture 90 that comprises the motion of the operator extending his left arm 54 anteriorly from a first position indicated by reference numeral 92 to a second position indicated by reference numeral 94. As shown, the left arm 54 is extended anteriorly such that the left hand 55 is generally close to (or generally coplanar with) the right hand 53. Note that this motion may be performed while the right arm 52 is being used to generate various commands using gesture 80 as shown in FIG. 6. The processor 14 may be configured to generate a compatible command that is indicative of a left mouse click based upon the gesture 80.

Referring now to FIG. 7B, illustrated therein is a gesture 104 which comprises the motion of the operator retracting his left arm 54 from the second position 94 back to the first position 92. The processor 14 may be configured to generate a right-click event based on the gesture 104.

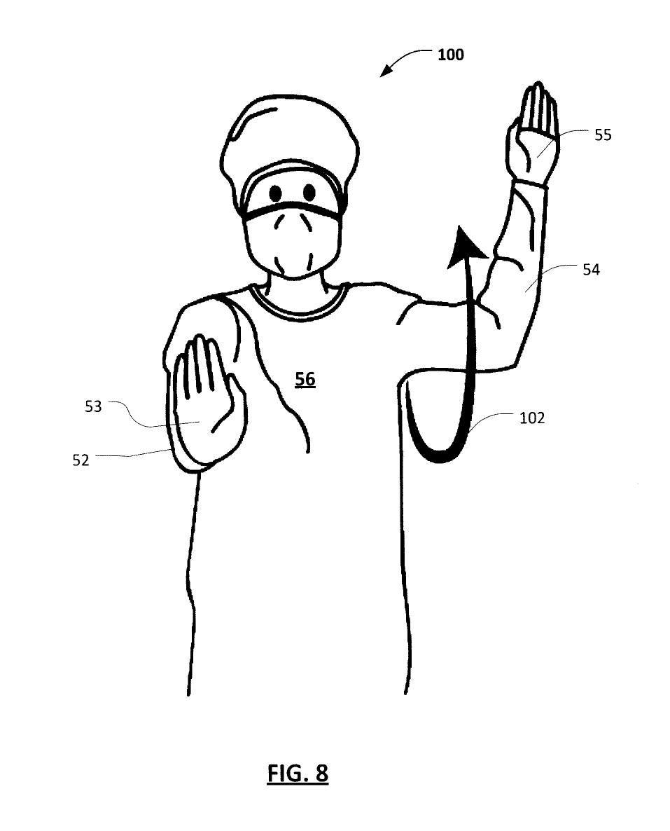

Referring now to FIG. 8, illustrated therein is the gesture 100 that comprises an upward motion of the left arm 54 and left hand 55 as indicated by the arrow 102. This gesture 100 may also be performed while the right arm 52 is being used to generate various commands using gesture 80 as shown in FIG. 6. The processor 14 may be configured to generate a compatible command that is indicative of a right mouse click based upon the gesture 100.

In some embodiments, the combination of gestures 80, 90, 100 could be used to generate various compatible commands that can be generated by a standard two-button mouse. For example, gesture 80 could be used to indicate various directions of mouse movements and gestures 90 and 100 could be used to generate left or right mouse clicks.

Alternatively, the usage of the arms may be reversed such that the left arm 54 is used for gesture 80 while the right arm 52 is used for gestures 90 and 100. The reversal may be helpful for operators who are left-handed.

The gestures 50, 60, 70, 80, 90, 100 shown in FIGS. 3-8 are selected so that they generally occur within the volume of recognition 30. That is, the operator could generally perform the gestures within the volume of recognition 30, which is indicative of a sterile space. In view of the above, the set of gestures 50, 60, 70, 80, 90, and 100 allow the processor 14 to generate a number of commands that are useful for controlling the electronic device 16 to access medical information based upon activities that are performed within a space that is generally sterile. This could help maintain a sterile environment for carrying out an invasive medical procedure.

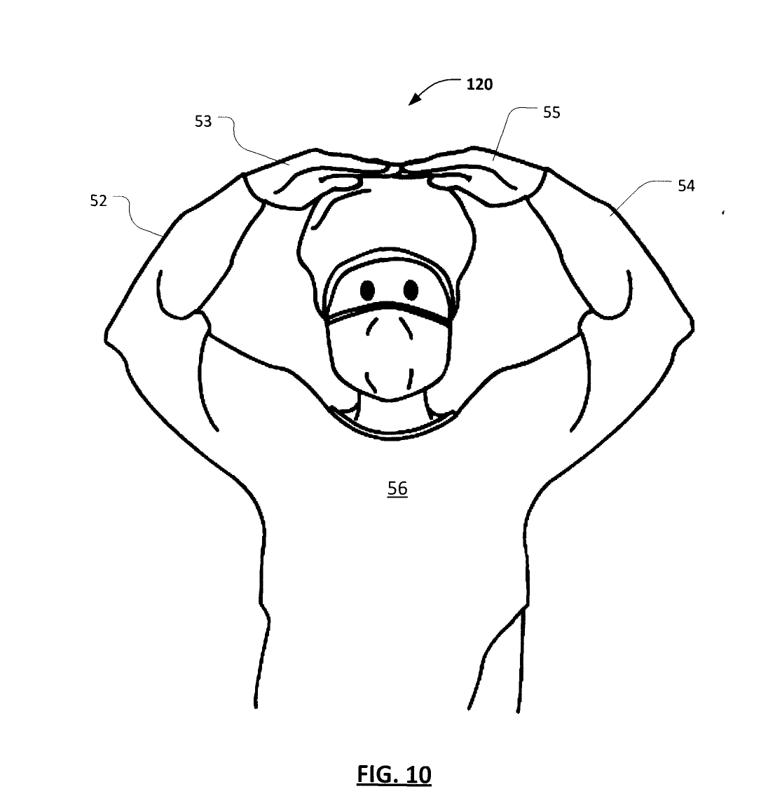

Referring now to FIGS. 9, 10 and 11 illustrated therein are gestures 110, 120, 130 that may be extracted by the processor 14 from the image data and depth data.

The gesture 110 comprises the operator holding his hands 53 and 55 apart and above his shoulders (e.g. in a surrender position). The gesture 110 may be used to calibrate the camera 12.

The gesture 120 comprises the operator holding his hands 53 and 55 over and in front of his head with the fingers of each hand 53 and 55 pointing towards each other. The hands and the fingers of the operator in this gesture are in-front of the operator's head and not touching it, as the operator's head is generally considered a non-sterilized area. The gesture 120 may be used to enter a hibernate mode (e.g. to temporally turn off the camera 12 and/or processor 14).

In some embodiments, the processor 14 may be configured to lock the system when the hands of the operator are raised above the head. The processor 14 may be configured to unlock the system when the operator's hands are lowered below the neck. The processor 14 may be configured to stop generating commands when the system is in the lock mode.

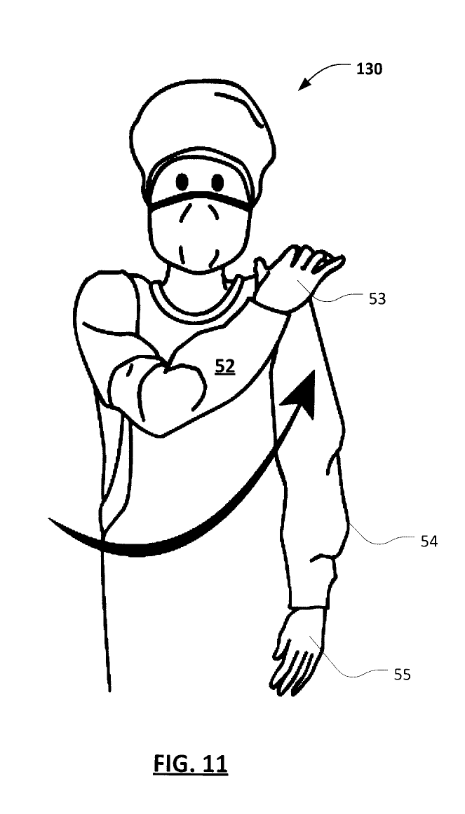

Referring now to FIG. 11, the gesture 130 comprises movement of the right arm 52 towards the left shoulder as indicated by directional arrow 132. The processor 14 may be configured to switch between various recognition modes. For example, in a first mode, the processor 14 may be in a scroll mode and be configured to extract gestures 60, 70, 80 indicative of various directions of scrolling. In a second mode, which could be triggered by a subsequent execution of the gesture 130, the processor 14 may be configured to assume a mouse mode. In this mode, the processor may be configured to extract gestures 80, 90, 100 indicative of cursor movements corresponding to those of a traditional mouse.

In some embodiments, if the operator's left hand 55 is hanging by their hip as shown in gesture 80, the processor 14 may be configured to enter the mouse mode. In the mouse mode, the right hand controls the mouse movement relative to a neutral point between the shoulder and waist. The activities of the left hand may be used to generate mouse click commands. For example, a left click could be generated in the case where the left hand is moved outwardly to the anterior. Moving the left hand back may be used to generate a right click command. Bringing the left hand back to the neutral positions may be used to generate a command that is indicative of releasing the mouse button.

It should be understood that the above described gesture extraction processes are provided for illustrative purposes, and that other gestures may be used to generate compatible commands. Compatible commands may include commands that can be generated using a keyboard and/or a mouse that is compliant with existing standards. In some embodiments, the compatible commands generated by the processor 14 may emulate commands from other input devices, such as human interface device (HID) signals.

In some embodiments, the processor 14 may be configured to extract one or more of the following gestures. The gesture data may then be used to generate one or more commands that manipulate Boolean-type variables (e.g. True/False, 1/0, Yes/No).

The processor may be configured to recognize the operator having: (i) his hands touching above shoulder line, (ii) hands crossed over the midline making an X with the forearms, hands superior to the intersection point, (iii) hands crossed over the midline making an X with the forearms, hands inferior to the intersection point, (iv) both elbows and both shoulders at 90 degrees with the hands in the same coronal plane as the chest, (iv) either hand crossing over the midline of the chest, and/or (v) either hand crossing over the shoulder line and/or (vii) a single elbow and the ipsilateral shoulder at 90 degrees with the hand in the same coronal plane as the chest.

In some embodiments, one or more recognized gestures may comprise one or more “bumps” in various directions (e.g. forward/backward/up/down taps in the air). In some embodiments, one or more recognize gestures may comprise swipes and/or the motion of bringing the hands together, which may be used to toggle the processor 14 between scroll mode and mouse modes.

Referring back to FIG. 1, the processor 14 may be part of the gesture-based control device 20 which interfaces between the camera 12 and the electronic device 16.

The gesture-based control device 20 may allow the electronic device 16 for displaying medical information to receive certain input commands that are compatible with the electronic device 16. For example, a PACS personal computer could receive compatible input commands through input ports for a standard keyboard and mouse. Thus, the gesture-based control device 20 may allow use of the gesture-based control system 10 without modifying the electronic device 16.

In some embodiments, the gesture-based control device 20 may emulate a standard keyboard and mouse. Accordingly, the electronic device 16 may recognize the gesture-based control device 20 as a standard (class-compliant) keyboard and/or mouse. Furthermore, the processor 14 may generate compatible commands that are indicative of input commands that may be provided by a standard keyboard or a mouse. For example, the compatible commands generated by the processor 14 may include keyboard and mouse events, including key presses, cursor movement, mouse button events, or mouse scroll-wheel events. By emulating a class-compliant keyboard or mouse it may be possible to use the gesture-based control system 10 with the electronic device 16 without modification.

Referring now to FIG. 12, illustrated therein is an exemplary configuration of the communication module 24 according to some embodiments. The communication module 24 may include two microcontrollers 142 and 144 in communication with one another (e.g. via a TTL-serial link). The microcontroller 142 may be a USB serial controller and the microcontroller 144 may be a serial controller. When coupled to the electronic device 16 (e.g. a PACS computer) the electronic device 16 may recognizes the communication module 24 as a USB keyboard and/or mouse device. The processor 14 may recognize the communication module 24 as a USB-serial adapter. The processor 14 may send compatible commands that it has generated to the USB serial controller 142, which then forwards them via the TTL-serial link 146 to the USB mouse/keyboard controller 144. The USB mouse/keyboard controller 144 parses these commands, and sends the corresponding keyboard and mouse events to the electronic device 16, which may be a PACS computer.

In some embodiments, the TTL-serial link 146 within the communication module 24 could be replaced with a wireless link, or an optical link, or a network connection.

In some embodiments, the TTL-serial link 146 may be opto-isolated.

The communication module 24 is shown as being integrated with the processor 14 to form the gesture-based control device 20. The gesture-based control device 20 could be implemented using some industrial or embedded PC hardware that contain a USB device controller (in addition to the USB host controller common in consumer PCs). With appropriate drivers, these types of hardware could be used to implement the communication module 24 as part of the gesture-based control device 20. A simple USB cable would then connect the USB device port on the gesture-based control device 20 to the USB host port on the electronic device 16, which may be a PACS PC.

In some embodiments, the communication module 24 could be implemented by configuring a processor of the electronic device 16 (i.e. software-implemented communication module). For example, the processor of the electronic device 16 could be configured by installing a driver or library, to provide functionality equivalent to the hardware communication module 24 as described above. Furthermore, the processor in the electronic device 16 could be configured in the same manner as the processor 14 described herein above to generate compatible commands based upon the image and depth data. In such cases, the camera 12 may be attached directly to the electronic device 16. The processor on the electronic device 16 would be configured to recognize the gestures and generate appropriate commands. The processor may also send commands to the software-implemented communication module via a file handle, socket, or other such means. The software-implemented communication module would interpret these commands into keyboard and mouse events.

Referring again to FIG. 1, in some embodiments, there may be a feedback display 26 coupled to the processor 14. The feedback display 26 may be a suitable display device such as a LCD monitor for providing information about the gesture-based control device 20. The processor 14 may be configured to provide information to the operator such as the gesture that the processor 14 is currently “seeing” and the commands that it is generating. This may allow the operator to verify whether or not the processor 14 is recognizing intended gestures and generating compatible commands based on his activities.

In some embodiments, the electronic device 16 may be coupled to a rolling cart along with the feedback display 26, and the camera 12. This may allow the system 10 to function without need for long electronic cables.

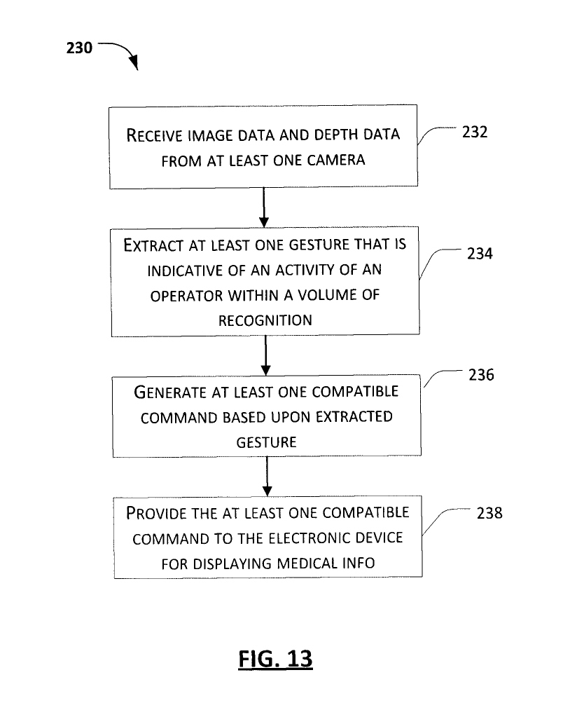

Referring now to FIG. 13, illustrated therein are exemplary steps of a gesture-based control method 230 according to some embodiments. One or more processors, for example, a processor in the electronic device 16 and/or the processor 14, may be configured to perform one or more steps of the method 230.

The method 230 beings at step 232 wherein image data and depth data is received from at least one camera. The camera may include one or more sensors for generating the image data and depth data. For example, the camera may be similar to or the same as the camera 12 described hereinabove.

At step 234, at least one gesture from the image data and the depth data that is indicative an activity of an operator within a volume of recognition is extracted. The volume of recognition defining a sterile space proximate to the operator. That is, the volume of recognition may be indicative of a sterile environment wherein medical staff may perform gestures with a low risk of contamination. In some embodiments, the volume of recognition may be similar to or the same as the volume of recognition 30 described herein above with reference to FIG. 2.

In some embodiments, the step 234 may include executing one or more of Foreground Segmentation process, Foreground Object Differentiation process, Skeleton Extraction process, and Gesture Recognition process as described herein above.

At step 236, at least one command that is compatible with at least one electronic device is generated based on the extracted at least one gesture. In some embodiments the at least one command may include one or more of a keyboard event and a mouse event that can be generated using one or more of a class compliant keyboard and mouse.

At step 238, the at least one compatible command is provided to the at least one electronic device as an input command to control the operation of the electronic device for displaying medical information.

The medical information systems described herein may increase the ability of a surgeon or another medical personal to access medical information such as medical images. This can aid the surgeon during medical procedures. For example, since the controls are gesture-based, there is no need to re-scrub or re-sterilize the control device and/or the portion of the surgeon that interacted with the control device. This may allow the hospital to save time and money, and thereby encourage (or at least does not discourage) surgeons from accessing the medical information system during the procedure instead of relying on their recollection of how the anatomy was organized.

While the above description provides examples of one or more apparatus, systems and methods, it will be appreciated that other apparatus, systems and methods may be within the scope of the present description as interpreted by one of skill in the art.

1. A gesture recognition apparatus comprising at least one processor configured to couple to at least one camera and at least one electronic device for displaying medical information, the at least one processor configured to:
a) receive image data and depth data from the at least one camera;
b) extract at least one gesture from the image data and the depth data that is indicative of an activity of an operator within a volume of recognition, the volume of recognition being indicative of a sterile space proximate to the operator;
c) generate at least one command that is compatible with the at least one electronic device based on the extracted at least one gesture; and
d) provide the at least one compatible command to the at least one electronic device as an input command.

2. The apparatus of claim 1, wherein the volume of recognition extends anteriorly from the operator.

3. The apparatus of claim 2, wherein the volume of recognition has a height that extends between a waist region of the operator to a head region of the operator.

4. The apparatus of claim 2, wherein the volume of recognition has a width that extends between opposed shoulder regions of the operator.

5. The apparatus of claim 2, wherein the volume of recognition has a depth length that extends arms-length from a chest region of the operator.

6. The apparatus of claim 1, wherein the processor is further configured to recognize at least one positional landmark, the positional landmark being operable to assist with gesture extraction from the image data and the depth data.

7. The apparatus of claim 6, wherein the at least one positional landmarks is defined relative to the operator.

8. The apparatus of claim 1, wherein the at least one gesture extracted by the processor includes a first gesture indicative of the operator extending both arms anteriorly from a chest of the operator.

9. The apparatus of claim 8, wherein the first gesture further comprises positioning palms of hands of the operator to face each other and flexing metacarpophalangeal joints so that fingers of each of the hands are pointing towards the fingers of the other hand.

10. The apparatus of claim 8, wherein the processor is further configured to extract a relative position of one hand to another hand of the operator in the first gesture.

11. The apparatus of claim 1, wherein the at least one gesture extracted by the processor includes a second gesture indicative of the operator extending one arm anteriorly and positioning a portion of the arm relative to a shoulder of the operator, the arm being indicative of a joystick on a multidirectional hinge at the shoulder.

12. The apparatus of claim 11, wherein the processor is further configured to:
a) define a dwell area and a virtual grid in a plane transverse to the length of the extended arm, the grid having a plurality of distinct areas;
b) determine which of the distinct areas is being selected by the operator based upon a location of the portion of the extended arm; and
c) generate the at least one compatible command based upon a distance between the dwell area and the location of the portion of the extended arm

13. The apparatus of claim 1, wherein the at least one gesture extracted by the processor includes a third gesture indicative of the operator extending an arm anteriorly in a pushing motion.

14. The apparatus of claim 1, wherein the at least one gesture extracted by the processor includes a fourth gesture indicative of the operator moving an arm and a hand upwards such that the hand is in a similar level to a head of the operator.

15. The apparatus of claim 1, wherein the at least one command emulates input commands generated by at least one of a keyboard and a mouse.

16. The apparatus of claim 1, wherein the processor is configured to emulate at least one of a keyboard and a mouse such that when the apparatus is connected to the at least one electronic device, the apparatus is recognized as at least one of a class compliant keyboard and class compliant mouse.

17. The apparatus of claim 1, further comprising a display device connected to the at least one processor, the at least one processor configured to provide feedback indicative of the at least one gesture that is being recognized via the display device.

18. A gesture-based control method comprising:
a) receiving image data and depth data from at least one camera;
b) extracting at least one gesture from the image data and the depth data that is indicative of an activity of an operator within a volume of recognition, the volume of recognition being indicative of a sterile space proximate to the operator;
c) generating at least one command that is compatible with at least one electronic device for displaying medical information based upon the extracted at least one gesture; and
d) providing the at least one compatible command to the at least one electronic device as an input command.

19. (canceled)

20. (canceled)

21. (canceled)

22. (canceled)

23. (canceled)

24. (canceled)

25. (canceled)

26. (canceled)

27. (canceled)

28. (canceled)

29. (canceled)

30. (canceled)

31. (canceled)

32. A medical information system comprising:
a) at least one camera configured to generate image data and depth data;
b) at least one electronic device configured to receive at least one input command and display medical information based upon the received at least one input command;
c) at least one processor operatively coupled to the at least one camera and the at least one electronic device, the processor configured to:
i. receive the image data and the depth data from the at least one camera;
ii. extract at least one gesture from the image data and the depth data that is indicative of an activity of an operator within a volume of recognition, the volume of recognition being indicative of a sterile space proximate to the operator;
iii. generate at least one command that is compatible with the at least one electronic device based on the extracted at least one gesture; and
iv. provide the at least one compatible command to the at least one electronic device as the at least one input command.

33. The apparatus of claim 1, wherein the volume of recognition has:
a) a height that extends between a waist region of the operator to a head region of the operator;
b) a width that extends between opposed shoulder regions of the operator; and
c) a length that extends arms-length from a chest region of the operator.
